(19) United States
(12) Patent Application Publication
(10) Pub. No.: US 2008/0179540 A1
(43) Pub. Date: Jul. 31, 2008

(54) SURFACE PLASMON ENHANCED FLUORESCENCE SENSOR

(75) Inventor: Hisashi OHTSUKA, Ashigarakami-gun (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM CORPORATION, Tokyo (JP)

(21) Appl. No.: 11/954,565

(22) Filed: Dec. 12, 2007

(30) Foreign Application Priority Data
Dec. 12, 2006 (JP) 2006-333926

(51) Int. Cl. G01J 1/58

(52) U.S. Cl. 250/458.1

(57) ABSTRACT

Exciting light is irradiated through a dielectric material block toward an interface between the dielectric material block and a metal film formed on one surface of the dielectric material block, such that total reflection conditions may be satisfied. A fluorescence detector detects fluorescence produced by a fluorescent substance, which is contained in a sample and produces the fluorescence by being excited by an evanescent wave oozing out from the interface when the exciting light impinges upon the interface. The exciting light has a wavelength causing the fluorescent substance, which is contained in the sample, to undergo multiphoton absorption. The fluorescence detector has sensitivity to a wavelength region of the fluorescence produced by the fluorescent substance through the multiphoton absorption.

### BACKGROUND OF THE INVENTION

1. Field of the Invention

This invention relates to a fluorescence sensor for detecting a specific substance, which is contained in a sample, by use of a fluorometric analysis technique. This invention particularly relates to a fluorescence sensor, in which surface plasmon enhancement is utilized.

2. Description of the Related Art

Heretofore, in fields of biological analyses, and the like, a fluorometric analysis technique has been used widely as an analysis technique, which has a high sensitivity and is easy to perform. The fluorometric analysis technique is the technique, wherein exciting light having a specific wavelength is irradiated to a sample expected to contain a substance to be detected, which substance is capable of producing fluorescence by being excited by the exciting light having the specific wavelength, wherein the fluorescence having thus been produced by the substance to be detected is detected, and wherein the presence of the substance to be detected is thereby confirmed. In cases where the substance to be detected is not a fluorescent substance, a technique has heretofore been conducted widely, wherein a specific binding substance, which has been labeled with a fluorescent substance and is capable of undergoing the specific binding with the substance to be detected, is brought into contact with the sample, wherein the fluorescence is detected in the same manner as that described above, and wherein the occurrence of the specific binding, i.e. the presence of the substance to be detected, is thereby confirmed.

FIG. 2 is a schematic side view showing an example of a conventional fluorescence sensor for carrying out a fluorometric analysis technique utilizing a labeled specific binding substance. By way of example, the fluorescence sensor illustrated in FIG. 2 is utilized for detecting an antigen 2, which is contained in a sample 1. The fluorescence sensor illustrated in FIG. 2 comprises a base plate 3, on which a primary antibody 4 capable of undergoing the specific binding with the antigen 2 has been coated. The fluorescence sensor also comprises a sample support section 5, which is formed on the base plate 3. The sample 1 is caused to flow within the sample support section 5. A secondary antibody 6, which has been labeled with a fluorescent substance 10 and is capable of undergoing the specific binding with the antigen 2, is then caused to flow within the sample support section 5. Thereafter, exciting light 8 is irradiated from a light source 7 toward a surface area of the base plate 3. Also, an operation for detecting the fluorescence is performed by a photodetector 9. In cases where the predetermined fluorescence is detected by the photodetector 9, the specific binding of the secondary antibody 6 and the antigen 2 with each other, i.e. the presence of the antigen 2 in the sample, is capable of being confirmed.

In the example described above, the substance whose presence is actually confirmed with the fluorescence detecting operation is the secondary antibody 6. If the secondary antibody 6 does not undergo the specific binding with the antigen 2, the secondary antibody 6 will be carried away and will not be present on the base plate 3. Therefore, in cases where the presence of the secondary antibody 6 on the base plate 3 is detected, the presence of the antigen 2, which is the substance to be detected, is capable of being confirmed indirectly.

Particularly, with the rapid advances made in enhancement of performance of photodetectors, such as the advances made in cooled CCD image sensors, in recent years, the fluorometric analysis technique described above has become the means essential for biological studies. The fluorometric analysis technique has also been used widely in fields other than the biological studies. In particular, with respect to the visible region, as in the cases of FITC (fluorescence wavelength: 525 nm, quantum yield: 0.6), Cy5 (fluorescence wavelength: 680 nm, quantum yield: 0.3), and the like, fluorescent dyes having high quantum yields exceeding 0.2, which serves as a criterion for use in practice, have been developed. It is thus expected that the fields of the application of the fluorometric analysis technique will become wide even further.

However, with the conventional fluorescence sensor as illustrated in FIG. 2, the problems are encountered in that noise is caused to occur by the reflected/scattered exciting light at an interface between the base plate 3 and the sample 1 and the light scattered by impurities/suspended materials M, and the like, other than the substance to be detected. Therefore, with the conventional fluorescence sensor, even though the performance of the photodetectors is enhanced, it is not always possible to enhance the signal-to-noise ratio in the fluorescence detecting operation.

As a technique for solving the problems described above, a fluorometric analysis technique utilizing an evanescent wave has heretofore been proposed. FIG. 3 is a schematic side view showing an example of a conventional fluorescence sensor for carrying out a fluorometric analysis technique utilizing an evanescent wave. In FIG. 3 (and in FIG. 1, which will be described later), similar elements are numbered with the same reference numerals with respect to FIG. 2.

In the fluorescence sensor illustrated in FIG. 3, in lieu of the base plate 3 described above, a prism (a dielectric material block) 13 is utilized. A metal film 20 has been formed on a surface of the prism 13. Also, the exciting light 8 having been produced by the light source 7 is irradiated through the prism 13 under the conditions such that the exciting light 8 may be totally reflected from the interface between the prism 13 and the metal film 20. With the constitution of the fluorescence sensor illustrated in FIG. 3, at the time at which the exciting light 8 is totally reflected from the interface described above, an evanescent wave 11 oozes out to the region in the vicinity of the interface described above, and the secondary antibody 6 is excited by the evanescent wave 11. Also, the fluorescence detecting operation is performed by the photodetector 9 located on the side of the sample 1, which side is opposite to the side of the prism 13. (In the cases of FIG. 3, the photodetector 9 is located on the upper side.)

With the fluorescence sensor illustrated in FIG. 3, the exciting light 8 is totally reflected from the aforesaid interface downwardly in FIG. 3. Therefore, in cases where the fluorescence detecting operation is performed from above, the problems do not occur in that an exciting light detection component constitutes the background with respect to a fluorescence detection signal. Also, the evanescent wave 11 is capable of reaching only a region of several hundreds of nanometers from the aforesaid interface. Therefore, the scattering from the impurities/suspended materials M contained in the sample 1 is capable of being suppressed. Accordingly, the evanescent fluorometric analysis technique described above has attracted particular attention for serving as a technique, which is capable of markedly suppressing (light) noise than with the conventional fluorometric analysis techniques, and with which the substance to be detected is capable of being fluorometrically analyzed in units of one molecule.

The fluorescence sensor illustrated in FIG. 3 is the surface plasmon enhanced fluorescence sensor, which has the sensitivity having been enhanced markedly among the fluorescence sensors utilizing the evanescent fluorometric analysis technique. With the surface plasmon enhanced fluorescence sensor, wherein the metal film 20 is formed, at the time at which the exciting light 8 is irradiated through the prism 13, the surface plasmon arises in the metal film 20, and the fluorescence is amplified by the electric field amplifying effect of the surface plasmon. A certain simulation has revealed that the fluorescence intensity in the cases described above is amplified by a factor of approximately 1,000.

The surface plasmon enhanced fluorescence sensor of the type described above is described in, for example, Japanese Patent No. 3562912. Also, as described in, for example, A. Kusumi et al., “Understanding with bio imaging”, pp. 104-113, Yodosha, there has been known a fluorescence sensor, in which the fluorescence detecting operation is performed by use of the evanescent fluorometric analysis technique without the surface plasmon enhancement being utilized particularly. In such cases, the metal film 20 illustrated in FIG. 3 is omitted, such that the sample 1 may be in direct contact with the prism 13, and the fluorescent substance, such as the secondary antibody 6, is excited by the evanescent wave 11, which oozes out from the interface between the sample 1 and the prism 13.

In the cases of the surface plasmon enhanced fluorescence sensor, as described in, for example, F. Yu et al., “Surface Plasmon Field-Enhanced Fluorescence Spectroscopy Studies of the Interaction between an Antibody and Its Surface-Coupled Antigen”, Analytical Chemistry, Vol. 75, pp. 2610-2617, 2003, the problems occur in that, if the fluorescent substance contained in the sample and the metal film are markedly close to each other, energy having been excited in the fluorescent substance will undergo transition to the metal film before causing the fluorescent substance to produce the fluorescence, and a phenomenon of fluorescence production failure (i.e., the so-called metal quenching) will thus arise. In the literature described above, in order to cope with the metal quenching described above, a technique is proposed, wherein a self-organizing film (SAM) is formed on the metal film, and wherein the fluorescent substance contained in the sample and the metal film are spaced away from each other by a distance equal to at least the thickness of the SAM. In FIG. 3, the SAM is represented by the reference numeral 21.

With the fluorescence sensors as described above, wherein the difference (i.e., the so-called Stokes' shift) between the excitation wavelength for the fluorescent substance and the fluorescence wavelength is comparatively small, the problems are encountered in that light scattering noise due to the exciting light mixes into the fluorescence detection signal, and in that the signal-to-noise ratio of the measurement signal is thus not capable of being kept high. For example, in the cases of cy5 described above, the fluorescence wavelength is 680 nm with respect to the excitation wavelength falling within the range of 635 nm to 645 nm, and the Stokes' shift is thus equal to at most approximately 40 nm. Therefore, ordinarily, at the time of the fluorescence detecting operation, a wavelength separation filter referred to as the sharp cut filter, such as a band pass filter, is located at a position just before the photodetector.

However, the wavelength separation capability of the aforesaid type of the filter is not sufficient for coping with the Stokes' shift as described above. Therefore, light noise often remains mixed in the measurement signal. Also, with the aforesaid type of the filter, which ordinarily has a markedly low transmittance, the problems occur in that the quantity of the fluorescence capable of being detected becomes small, and in that the signal-to-noise ratio of the measurement signal is thus caused to become low. Further, with the aforesaid type of the filter, the cost of which is high, the problems are encountered in that the cost of the fluorescence sensor is not capable of being kept low.

Also, there has been known a certain type of organic fluorescent dye, which produces the fluorescence (i.e., the so-called up-conversion fluorescence) having a wavelength shorter than the excitation wavelength through two-photon absorption. The aforesaid type of the organic fluorescent dye is described in, for example, a literature of G. S. He et al., “Optical limiting effect in a two-photon absorption dye doped solid matrix”, Applied Physics Letters, Vol. 67, Issue 17, pp. 2433-2435, 1995, By way of example, it has been known that rhodamine B produces the orange fluorescence having a wavelength in the vicinity of 580 nm when being excited by the exciting light having a wavelength of approximately 800 nm of the infrared region. In the example described above, the difference between the exciting light wavelength and the fluorescence wavelength is equal to at least 200 nm, and the separation of the exciting light wavelength and the fluorescence wavelength from each other becomes easy. Therefore, in cases where the aforesaid dye, such as rhodamine B, is applied to the fluorescence sensor, the wavelength separation filter as described above need not be used, and the fluorescence is capable of being detected with a high signal-to-noise ratio.

However, ordinarily, the fluorescent substance capable of undergoing the multiphoton absorption, such as the two-photon absorption, exhibits a markedly low quantum yield. Therefore, in order for the fluorescent substance described above to be excited, a markedly high electric field is required. Therefore, heretofore, such that the multiphoton absorption may occur, a short pulse laser, such as a Q-switch laser, has been used, and the excitation has been performed by the utilization of a peak value, at which the laser output becomes high instantaneously.

Therefore, in cases where it is intended to constitute a fluorescence sensor for detecting the up-conversion fluorescence with respect to a fluorescent substance capable of undergoing the multiphoton absorption, it becomes necessary to use an exciting light source, such as the Q-switch later described above, the cost of which is high and the size of which is large. As a result, in such cases, the size of the fluorescence sensor is not capable of being kept small, the cost of the fluorescence sensor is not capable of being kept low, and the fluorescence sensor which is easy to operate for ordinary users is not capable of being obtained.

### SUMMARY OF THE INVENTION

The primary object of the present invention is to provide a fluorescence sensor, which is capable of detecting fluorescence with a high signal-to-noise ratio, and which is capable of being kept small in size and low in cost.

The present invention provides a surface plasmon enhanced fluorescence sensor, in which the effect of surface plasmon enhancement is utilized, such that multiphoton absorption is capable of being caused occur in cases where a light source having a comparatively low output is used. Specifically, the present invention provides a surface plasmon enhanced fluorescence sensor, comprising:
i) a light source, which produces exciting light having a predetermined wavelength,
ii) a dielectric material block, which has been formed from a material capable of transmitting the exciting light,
iii) a metal film, which has been formed on one surface of the dielectric material block,
iv) a sample support section for supporting a sample at a position in the vicinity of the metal film,
v) an irradiating optical system for irradiating the exciting light through the dielectric material block toward an interface between the dielectric material block and the metal film, such that total reflection conditions may be satisfied, and
vi) fluorescence detecting means for detecting fluorescence having been produced by a fluorescent substance, which is contained in the sample, the fluorescent substance producing the fluorescence by being excited by an evanescent wave oozing out from the interface at the time at which the exciting light has impinged upon the interface,

the light source being constituted of a light source capable of producing the exciting light having a wavelength capable of causing the fluorescent substance, which is contained in the sample, to undergo multiphoton absorption,

the fluorescence detecting means being constituted of a means having sensitivity with respect to a wavelength region of the fluorescence, which the fluorescent substance produces by undergoing the multiphoton absorption.

The surface plasmon enhanced fluorescence sensor in accordance with the present invention should preferably be constituted for detection with respect to the sample containing, as the fluorescent substance, a fluorescent substance selected from the group consisting of rhodamine B, a benzothiadiazole fluorescent dye, a coumarin dye, a stilbene type compound, a dihydrophenanthrene type compound, and a fluorene compound. Specifically, in such cases, the light source is constituted of a light source capable of producing the exciting light having a wavelength capable of causing the fluorescent substance, which is selected from the group described above, to undergo the multiphoton absorption.

Also, the surface plasmon enhanced fluorescence sensor in accordance with the present invention should preferably be modified such that an inflexible film made from a hydrophobic material is formed on the metal film. In such cases, the inflexible film should preferably be constituted of a polymer

With the surface plasmon enhanced fluorescence sensor in accordance with the present invention, the light source for producing the exciting light is constituted of a light source capable of producing the exciting light having a wavelength capable of causing the fluorescent substance, which is contained in the sample, to undergo the multiphoton absorption. Also, the fluorescence detecting means is constituted of a means having the sensitivity with respect to the wavelength region of the fluorescence, which the fluorescent substance produces by undergoing the multiphoton absorption. Therefore, with the surface plasmon enhanced fluorescence sensor in accordance with the present invention, it is possible to detect the up-conversion fluorescence having been produced through the multiphoton absorption. Accordingly, with the surface plasmon enhanced fluorescence sensor in accordance with the present invention, the fluorescence having a large wavelength difference with respect to the exciting light (a large Stokes' shift) is capable of being detected with a high signal-to-noise ratio.

Also, with the surface plasmon enhanced fluorescence sensor in accordance with the present invention, the multiphoton absorption is caused to occur by the utilization of a high electric field, which is obtained through the surface plasmon enhancement. Therefore, as the exciting light source, it is not necessary to use a light source, such as the Q-switch later described above, the cost of which is high and the size of which is large. As a result, the cost of the fluorescence sensor is capable of being kept low, and the size of the fluorescence sensor is capable of being kept small.

Further, with the surface plasmon enhanced fluorescence sensor in accordance with the present invention, wherein the inflexible film made from the hydrophobic material is formed on the metal film, the problems are capable of being prevented from occurring in that the fluorescent substance contained in the sample liquid is located close to the metal film such that the metal quenching may occur. Therefore, in such cases, the metal quenching described above is not caused to occur. Accordingly, the electric field amplifying effect with the surface plasmon is capable of being obtained reliably, and the fluorescence is capable of being detected with a markedly high sensitivity.

Furthermore, with the surface plasmon enhanced fluorescence sensor in accordance with the present invention, wherein the inflexible film is made from the hydrophobic material, the problems do not occur in that the molecules, which will cause the quenching to occur, such as metal ions and dissolved oxygen present in the sample liquid, enter into the interior of the inflexible film. Therefore, the problems are capable of being prevented from occurring in that the molecules described above deprive the exciting light of the excitation energy. Accordingly, in such cases, a markedly high level of excitation energy is capable of being obtained, and the fluorescence is capable of being detected with a markedly high sensitivity.

The term “inflexible film” as used herein means the film, which has the rigidity to an extent such that the film may not be deformed to a different film thickness during the ordinary use of the sensor.

### BRIEF DESCRIPTION OF THE DRAWINGS

FIG. 1 is a schematic side view showing an embodiment of the surface plasmon enhanced fluorescence sensor in accordance with the present invention,

FIG. 2 is a schematic side view showing an example of a conventional fluorescence sensor for carrying out a fluorometric analysis technique utilizing a labeled specific binding substance, and

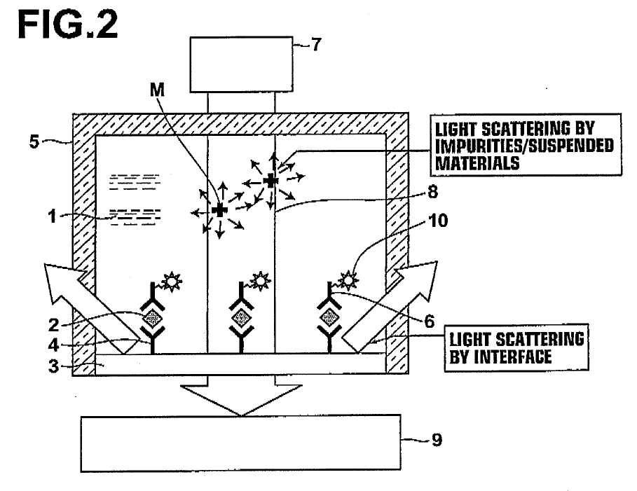

FIG. 3 is a schematic side view showing an example of a conventional fluorescence sensor for carrying out a fluorometric analysis technique utilizing an evanescent wave.

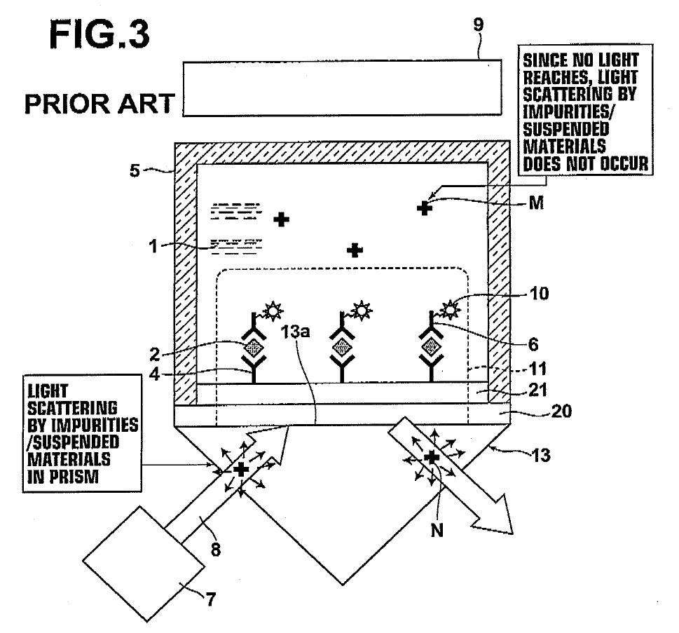

### DESCRIPTION OF THE PREFERRED EMBODIMENTS

The present invention will hereinbelow be described in further detail with reference to the accompanying drawings.

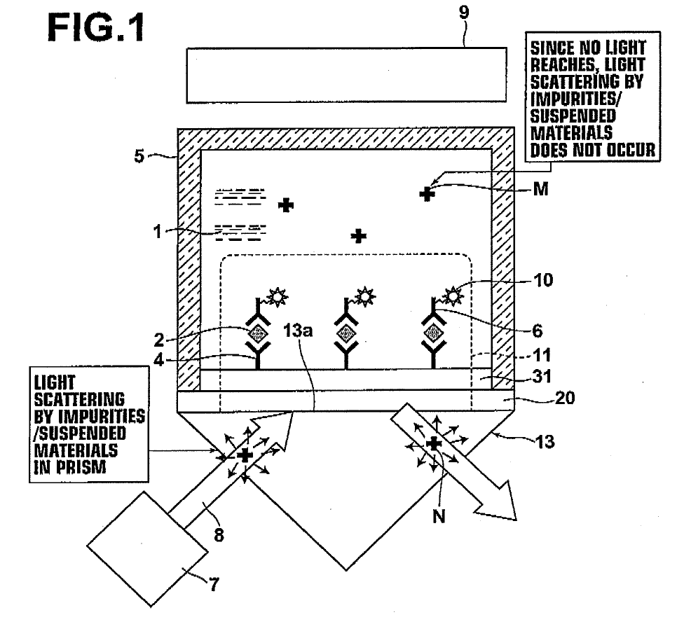

FIG. 1 is a schematic side view showing an embodiment of the surface plasmon enhanced fluorescence sensor in accordance with the present invention. As illustrated in FIG. 1, the fluorescence sensor comprises a light source 7, such as a semiconductor laser, for producing exciting light 8 having a wavelength of, for example, 800 nm. The fluorescence sensor also comprises a prism (a dielectric material block) 13, which is located such that the exciting light 8 having been produced by the light source 7, may enter from one end face of the prism 13 into the interior of the prism 13. The fluorescence sensor further comprises a metal film 20, which has been formed on one surface 13a of the prism 13. The fluorescence sensor still further comprises an inflexible film 31, which has been formed on the metal film 20 and which is constituted of a polymer. The fluorescence sensor also comprises a sample support section 5 for supporting a liquid-state sample 1 such that the sample 1 may be brought into contact with the inflexible film 31 from the side opposite to the prism 13. The fluorescence sensor further comprises a photodetector (fluorescence detecting means) 9, which is located above the sample support section 5.

In this embodiment, the light source 7 is located for irradiating the exciting light 8 through the prism 13 toward the interface between the prism 13 and the metal film 20, such that the total reflection conditions may be satisfied. Specifically, the light source 7 by itself constitutes the irradiating optical system for irradiating the exciting light 8 in the manner described above with respect to the prism 13. However, the fluorescence sensor is not limited the constitution described above. For example, alternatively, an irradiating optical system, which comprises a lens, a mirror, and the like, for irradiating the exciting light 8 in the manner described above, may be located as an independent system besides the light source 7.

By way of example, the prism 13 may be constituted of ZEONEX (trade name) 330R (refractive index: 1.50), supplied by Nippon Zeon Co., Ltd. The metal film 20 has been formed with processing, in which gold is formed on the one surface 13a of the prism 13 by use of a sputtering technique. The film thickness of the metal film 20 is set at 50 nm. Also, the inflexible film 31 has been formed with processing, in which a polystyrene type polymer having a refractive index of 1.59 is formed on the metal film 20 by use of a spin coating technique. The film thickness of the inflexible film 31 is set at 20 nm.

Besides the material described above, prism 13 may be formed by se of a known resin, a known optical glass, or the like. From the view point of the cost, the resin is more preferable than the optical glass. In cases where the prism 13 is made from a resin, the resin may be selected appropriately from a polymethyl methacrylate (PMMA), a polycarbonate (PC), an amorphous polyolefin (APO) containing a cycloolefin, and the like.

As the photodetector 9, it is possible to employ, for example, LAS-1000 plus (trade name), supplied by Fuji Photo Film Co., Ltd.

By way of example, the object of the detection with the embodiment of the fluorescence sensor is a CRP antigen 2 (molecular weight: 110,000 Da). A primary antibody (a monoclonal antibody) 4, which is capable of undergoing the specific binding with the CRP antigen 2, has been fixed on the inflexible film 31. The primary antibody 4 has been fixed to the inflexible film 31, which is constituted of a polymer, via, for example, PEG having a terminal introduced with a carboxyl group, by use of an amine coupling technique. Also, as a secondary antibody 6, a monoclonal antibody, which has been labeled with a fluorescent substance (rhodamine B) 10 that is a dye capable of undergoing the two-photon absorption, is employed. (The monoclonal antibody employed as the secondary antibody 6 varies in epitope (antigenic determinant) from the primary antibody 4.)

By way of example, the aforesaid amine coupling technique comprises the steps (1), (2), and (3) described below. The example described below is of the cases wherein a 30 μl (microliter) cuvette/cell is used.
(1) Activation of a —COOH Group at a Linker End (Terminal)

A solution, which has been prepared by mixing 0.1M (mol) NHS and 0.4M EDC together in an equal volume ratio, is added in an amount of 30 μl, and the resulting mixture is allowed to stand for 30 minutes at the room temperature.
NHS: N-Hydrooxysuccinimide
EDC: 1-Ethyl-3-(3-dimethylaminopropyl) carbodiimide
(2) Fixation of the Primary Antibody 4

After washing with a PBS buffer (pH 7.4) is performed five times, a primary antibody solution (500 μg/ml) is added in an amount of 30 μl, and the resulting mixture is allowed to stand for 30 to 60 minutes at the room temperature.
(3) Blocking of an Unreacted —COOH Group

After washing with the PBS buffer (pH 7.4) is performed five times, 1M ethanolamine (pH 8.5) is added in an amount of 30 μl, and the resulting mixture is allowed to stand for 20 minutes at the room temperature. Washing with the PBS buffer (pH 7.4) is then performed five times.

The light source 7 is not limited to the semiconductor laser described above and may be selected from the other various kinds of the known light sources. Also, the fluorescence detecting means is not limited to the photodetector 9 described above and may be selected from the other various kinds of the known devices, such as a CCD, a PD (a photodiode), a photomultiplier, and c-MOS. Further, in cases where the excitation wavelength is altered, a dye other than rhodamine B is capable of being employed as a label.

How the embodiment of the fluorescence sensor operates will be described hereinbelow by taking the cases of the detection of the CRP antigen 2, which is contained in the sample 1, as an example. Firstly, the liquid-state sample 1 is caused to flow within the sample support section 5. Thereafter, in the same manner, the secondary antibody 6, which has been labeled with the fluorescent substance 10 and which is capable of undergoing the specific binding with the CRP antigen 2, is caused to flow within the sample support section 6.

Thereafter, the exciting light 8 is irradiated from the light source 7 toward the prism 13, and the fluorescence detecting operation is performed by the photodetector 9. At this time, the evanescent wave 11 oozes out from the interface between the prism 13 and the metal film 20. Therefore, in cases where the CRP antigen 2 has been bound with the primary antibody 4, the secondary antibody 6 undergoes the binding with the antigen 2, and the fluorescent substance 10 acting as the label of the secondary antibody 6 is excited by the evanescent wave 11. The fluorescent substance 10 having thus been excited by the evanescent wave 11 produces the fluorescence having the predetermined wavelength, and the thus produced fluorescence is detected by the photodetector 9. In cases where the photodetector 9 has thus detected the fluorescence having the predetermined wavelength, it is thereby capable of being confirmed that the secondary antibody 6 has been bound with the CRP antigen 2, i.e. that the CRP antigen 2 is contained in the sample 1.

The evanescent wave 11 described above is capable of reaching only the region of approximately several hundreds of nanometers from the interface between the prism 13 and the metal film 20. Therefore, the scattering from the impurities/suspended materials M contained in the sample 1 is capable of being eliminated approximately perfectly. Also, the light, which has been scattered by impurities N contained in the prism 13, (which light is the ordinary propagated light) is blocked by the metal film 20 and does not impinge upon the photodetector 9. Accordingly, with this embodiment of the fluorescence sensor, the occurrence of light noise is capable of being eliminated approximately perfectly, and the fluorescence is capable of being detected with a markedly high signal-to-noise ratio.

The fluorescence produced by the fluorescent substance 10 will hereinbelow be described in detail. Rhodamine B acting as the fluorescent 10 has the characteristics such that, when being excited by the exciting light B having a wavelength of 800 nm, in cases where the exciting light 8 has a sufficiently high intensity, rhodamine B undergoes the two-photon absorption and produces the orange fluorescence having a peak wavelength in the vicinity of 580 nm. In this embodiment of the fluorescence sensor, wherein the metal film 20 has been formed on the one surface 13a of the prism 13, the surface plasmon is excited at the one surface 13a of the prism 13. Therefore, the intensity of the exciting light B is enhanced by the electric field amplifying effect of the surface plasmon, and the two-photon absorption described above is caused to occur.

The fluorescence having thus been produced has a difference in wavelength from the exciting light 8, which difference is as large as at least 200 nm. Therefore, in cases where a photodetector for principally detecting light having a wavelength in the vicinity of 580 nm is employed as the photodetector 9, the fluorescence is capable of being detected with a high signal-to-noise ratio without being adversely affected by the exciting light 8. Specifically, it has been found that the fluorescence detection sensitivity is capable of being improved by approximately 3 orders of ten over the cases wherein the two-photon absorption is not utilized.

Also, with this embodiment of the fluorescence sensor, wherein the electric field amplifying effect of the surface plasmon is utilized in order for the exciting light 8 having a high intensity to be obtained, it becomes possible to use the ordinary semiconductor laser, which is actuated continuously, as the light source 7, and a light source, such as a Q-switch laser, the cost of which is high and the size of which is large, need not be used. As a result, this embodiment of the fluorescence sensor is capable of being formed at a comparatively low cost and in a small size and is capable of being constituted as a simple measuring device, a simple diagnostic device, and the like, for ordinary household use.

Particularly, in the cases of this embodiment, wherein the wavelength of the exciting light 8 falls within the infrared region, noise of the exciting light due to the scattering, and the like, is not perceptible to the human eyes. Therefore, only the fluorescence having a wavelength in the vicinity of 580 nm is capable of being perceived easily, even though the fluorescence detecting means is not actuated particularly, the fluorescence detection is capable of being made with a high sensitivity. Also from the view point described above, this embodiment of the fluorescence sensor is appropriate for constituting a household use device.

Further, with this embodiment of the fluorescence sensor, wherein the inflexible film 31 having a film thickness of 20 nm is formed on the metal film 20, the problems are capable of being prevented from occurring in that the fluorescent substance 10 contained in the sample 1 becomes close to the metal film 20 to an extent such that the metal quenching may occur. Therefore, with this embodiment of the fluorescence sensor, the metal quenching described above is not caused to occur. Accordingly, the electric field amplifying effect with the surface plasmon is capable of being obtained reliably, and the fluorescence is capable of being detected with a markedly high sensitivity.

Furthermore, with this embodiment of the fluorescence sensor, wherein the inflexible film 31 is made from the polystyrene type polymer, which is the hydrophobic material, the problems do not occur in that the molecules, which will cause the quenching to occur, such as metal ions and dissolved oxygen present in the liquid-state sample 1, enter into the interior of the inflexible film 31. Therefore, the problems are capable of being prevented from occurring in that the molecules described above deprive the exciting light 8 of the excitation energy. Accordingly, with this embodiment of the fluorescence sensor, a markedly high level of excitation energy is capable of being obtained, and the fluorescence is capable of being detected with a markedly high sensitivity.

In this embodiment of the fluorescence sensor, the evanescent wave 11 does not reach the secondary antibody 6, which has not been bound with the CRP antigen 2 and is spaced away from the surface of the inflexible film 31. Therefore, the secondary antibody 6, which has not been bound with the CRP antigen 2 and is spaced away from the surface of the inflexible film 31, does not produce the fluorescence. Accordingly, in cases where the secondary antibody 6 as described above is being suspended in the sample 1, no problems occur with respect to the measurement, and a washing operation, i. e. a B/F separating operation (a bound/free separating operation) need not be performed for each stage of the measurement.

In the embodiment described above, the fluorescent substance is caused to undergo the two-photon absorption. However, the surface plasmon enhanced fluorescence sensor in accordance with the present invention is not limited to the cases of the two-photon absorption and may be constituted such that the multiphoton absorption, such as three-photon absorption, may be caused to occur.

Also, the surface plasmon enhanced fluorescence sensor in accordance with the present invention is not limited to the embodiment, which is constituted for the detection with respect to the sample containing rhodamine B, and may be constituted for detection with respect to the sample containing, as the substance, a substance selected from the group consisting of a benzothiadiazole fluorescent dye, a coumarin dye, a stilbene type compound, a dihydrophenanthrene type compound, and a fluorene compound. The surface plasmon enhanced fluorescence sensor in accordance with the present invention may thus be constituted such that the substance selected from the group described above may be caused to undergo the multiphoton absorption.

What is claimed is:

1. A surface plasmon enhanced fluorescence sensor, comprising:
i) a light source, which produces exciting light having a predetermined wavelength,
ii) a dielectric material block, which has been formed from a material capable of transmitting the exciting light,
iii) a metal film, which has been formed on one surface of the dielectric material block,
iv) a sample support section for supporting a sample at a position in the vicinity of the metal film,
v) an irradiating optical system for irradiating the exciting light through the dielectric material block toward an interface between the dielectric material block and the metal film, such that total reflection conditions may be satisfied, and
vi) fluorescence detecting means for detecting fluorescence having been produced by a fluorescent substance, which is contained in the sample, the fluorescent substance producing the fluorescence by being excited by an evanescent wave oozing out from the interface at the time at which the exciting light has impinged upon the interface,
the light source being constituted of a light source capable of producing the exciting light having a wavelength capable of causing the fluorescent substance, which is contained in the sample, to undergo multiphoton absorption,
the fluorescence detecting means being constituted of a means having sensitivity with respect to a wavelength region of the fluorescence, which the fluorescent substance produces by undergoing the multiphoton absorption.

2. A surface plaston enhanced fluorescence sensor as defined in claim 1 wherein the light source is constituted of a light source capable of producing the exciting light having a wavelength capable of causing the fluorescent substance, which is contained in the sample, to undergo the multiphoton absorption,
the fluorescent substance being selected from the group consisting of rhodamine B, a benzothiadiazole fluorescent dye, a coumarin dye, a stilbene type compound, a dihydrophenanthrene type compound, and a fluorene compound.

3. A surface plasmon enhanced fluorescence sensor as defined in claim 1 wherein an inflexible film made from a hydrophobic material is formed on the metal film.

4. A surface plasmon enhanced fluorescence sensor as defined in claim 2 wherein an inflexible film made from a hydrophobic material is formed on the metal film.

5. A surface plasmon enhanced fluorescence sensor as defined in claim 3 wherein the inflexible film is constituted of a polymer.

6. A surface plasmon enhanced fluorescence sensor as defined in claim 4 wherein the inflexible film is constituted of a polymer.

7. A surface plasmon enhanced fluorescence sensor as defined in claim 3 wherein a substance for attracting the fluorescent substance has been fixed onto the inflexible film.

8. A surface plasmon enhanced fluorescence sensor as defined in claim 7 wherein the substance, which has been fixed onto the inflexible film, is an antibody that is capable of undergoing binding with an antigen capable of undergoing the binding with the substance, which is contained in the sample and which produces the fluorescence.

9. A surface plasmon enhanced fluorescence sensor as defined in claim 4 wherein a substance for attracting the fluorescent substance has been fixed onto the inflexible film.

10. A surface plasmon enhanced fluorescence sensor as defined in claim 9 wherein the substance, which has been fixed onto the inflexible film, is an antibody that is capable of undergoing binding with an antigen capable of undergoing the binding with the fluorescent substance.
